(19) United States
(12) Patent Application Publication
(10) Pub. No.: US 2006/0021925 A1
(43) Pub. Date: Feb. 2, 2006

(54) Re-usable structure which attaches to the same filter head as originally intended to receive a throw-away spin-on

(76) Inventor: Jack Stifelman, Bolivar, MO (US)

Correspondence Address: Jack Stifelman;APT 1, 700 NO WATER AVE, BOULIVAR, MO, 65613, US

(21) Appl. No.: 11/189,365

(22) Filed: Jul. 26, 2005

Related U.S. Application Data
(60) Provisional application No. 60/598,230, filed on Aug. 2, 2004.

(51) Int. Cl. B01D 27/08; B01D 35/30

(52) U.S. Cl. 210/232; 210/440; 210/444

(57) ABSTRACT

A re-usable, spin-on filter cannister for hydraulic use, which can attach to a block-like head; said head being previously existent for attachment of a conventional, throw-way, spin-on type cannister. The invention is designed with metal parts which can be assembled or dis-assembled without damage. Thus, when the spent filter element is discarded, the housing parts can be reused with a fresh element, without physical alteration to any of the metal container parts. The assembly/dis-assembly mode, which enables reuse, is by means of a radial displacement of split rings which, in engagement with the cannister and plate, act to contain the hydraulic stresses within the filter assembly.

### CROSS REFERENCE TO RELATED APPLICATIONS

(not applicable)

### STATEMENT REGARDING FEDERALLY SPONSORED RESEARCH OR DEVELOPMENT

(not applicable)

### REFERENCE TO A “SEQUENTIAL LISTING”

(not applicable)

### BACKGROUND OF THE INVENTION

The use of the spin-on can format, a system whereby a filter element is packaged within a lightweight steel container, and that container not being reusable for replacing with a fresh element, has been both the dominant economic choice, and importantly, the one whereby contamination control is better achieved during the servicing operation.

In general, these throw-away designs have, at the attaching end, a plate structure with features defining an internal threading means, and a seal(s) arrangement defining inlet and outlet hydraulic flows in order to mate with a permanent, block head structure, from which head structure the fluid arrives and to where it exits after filtration.

Various schemes to seal the plate structure to the drawn steel shell were devised:—In the most common embodiment, the plate is a two-piece, steel construction, with one piece serving to both locate a resilient face seal to seal against the head, and to join the shell material via a lock seam. Interlocked in that seam is sealant previously layed down on the plate portion. In another approach, the plate is of a one-piece aluminum casting, also defining the threading attachment, and sealing arrangements to contain internal system pressures and to direct the flow paths. In this latter cast version, the sealing means between plate and shell is done with a piston radial seal. After the cast plate is inserted into the open mouth of the shell, an extended vertical portion of the shell is spun inwards to extend within the O.D. of the plate; the plate is thus retained and sealed against internal fluid pressure.

But, reversion to a traditional, permanent style filter (defined as a block like head and shell/cannister), as an environmental solution, has serious drawbacks which, it can be argued, are: (a) a reversion to an inferior contamination control mechanism; (b) will entail high costs to the general infrastructures to implement, both for filter manufacturers, and for the customers that use the product; (c); will still leave the disposal of the oil and the spent element as environmental concerns; and (d); will mean the use of large attaching threads between shell and head in order to allow for element serviving, thus deriving an unnecesarily large head mass. But, if significant demand would grow to replace the throw-away type of spin-on with an alternate system, this invention can deal with cleanliness and cost issues in such a way that it does not appreciably impact the evolved infrastructures, and which will sustain the evolved techniques of contamination control during the servicing interval, as demonstrated

The invention will thus be a preferred answer to environmental dictum that preclude the use of the classic throw away spin-on. Importantly, the invention sustains a choice of traditional spin-on or reusable spin-on, both being attachable to the classic, compact head as derived for the throw-away design.

### BRIEF SUMMARY OF THE INVENTION

The present invention generally comprises a reusable cannister assembly, which is similar in size and shape to a conventional throw-away spin-on filter, except the shell portion is preferably made of heavier gage metal, and except that the length of the counterbore at the open end of the shell, which is to receive the connecting plate, is of a length to make it flush with the height of the plat. Further, once the shell is formed, there is no require-ment that a portion of its mouth be bent to form a seam, it can be heat treated to allow higher pressure ratings than that of conventional spin-on shells.

In order to secure the plate against the hydraulic burst forces, a ring in two 180 degree halves mate to form a 360 degree ring, which mating simultaneously engages beneath the shoulder formed by the expanded open end of the shell and, by virtue of the “L” section of the rings, extends as a rim which overlaps the plate. Bolts are used to secure the ring halves to the strength equivalent to a continuous ring structure. Thus, the separable ring halves are what enables the plate, and then the inner element, to be separated from the shell without damage to plate or shell. With a new element reinserted, the original metal parts (or spare parts) are used to complete the assembly with a new filter element. The refurbishing is preferably done away from the machine where it functioned, and the unit can be stocked as a replacement part, thus effecting the safest method of re-attaching; i.e. which is the same procedure as used with the throw away spin-on at the machine site.

It is obvious that with the general approach taken, a variety of attaching plate profiles can be accomodated, thus enabling the invention to be adapted so as to fit a variety of head attachment profiles.

The re-encapsulation is preferably done away from the machine where it functioned, and there the unit can be stocked as a replacement part, thus effecting the safest method of re-attaching; i.e. the same procedure as used with the throw away spin-on at the machine site. It is obvious that with the general approach taken, a variety of attaching plate profiles can be accomodated, thus enabling the invention to be adapted so as to fit a variety of spin-on attachment profiles.

### BRIEF DESCRIPTION OF THE SEVERAL VIEWS OF THE DRAWING

FIG. I. is a top view of the dis-assembled parts of a take-apart spin-on invention

FIG. II. is an elevation section of the dis-assembled parts of a take-apart spin-on invention.

FIG. III is an elevation view of one style of head as candidate for the invention. The view faces the inlet port.

FIG. IV is an elevation view of a second style of head as candidate for application for the invention. The view faces the inlet port.

FIG. V is an elevation section through FIG. III.

FIG. VI is an elevation section through FIG. IV.

FIG. VII is an elevation section of one style of spin-on style of throw-away, as candidate for application of the invention.

FIG. VIII is an elevation section of a second style of spin-on style of throw-away, as candidate for application of the invention.

FIG. IX is a partial, elevation section of an alternate construction for the item of FIG. VIII.

FIG. X is an elevation section showing the mating of the head of FIG. V and the spin-on of FIG. VIII

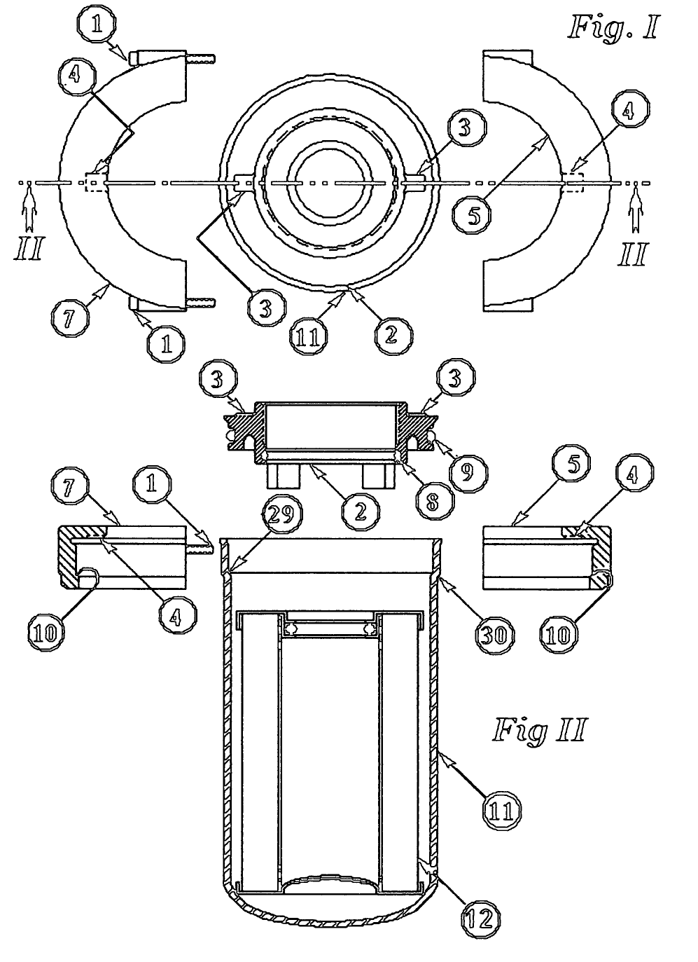

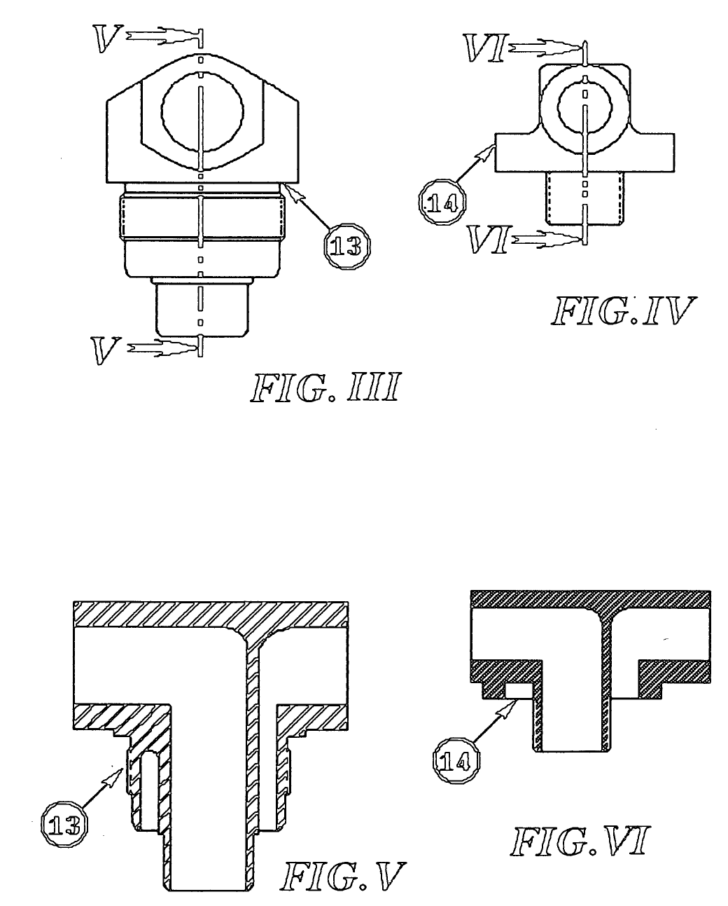

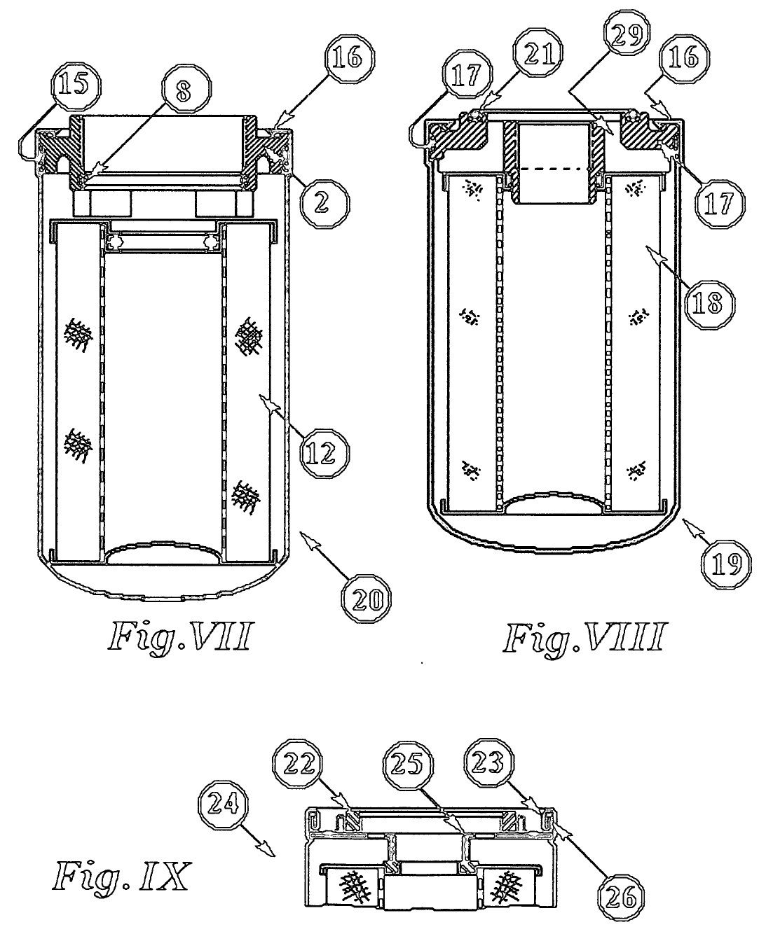

FIG. XI is an elevation section showing the mating of the head of FIG. 4. with the spin-on of FIG. VIII

FIG. XII is an elevation section showing the mating of the head of FIG. IV with the spin-on of FIG. IX

FIG. XIII is an elevation section of the spin-on invention to replace FIG. VII.

FIG. XIV is an elevation section of the invention to replace FIG. VIII.

### DETAILED DESCRIPTION OF THE INVENTION

FIG. I represents the exploded, top view of the invention, either ready for removal of a spent element (12), or ready for re-assembly after insertion of a new element (12). Loose screws (1) will clamp the ring halves (5) and (7) into a 360 degree effective ring at the the completed assembly. Plate (2) and shell (11) are shown concentrically. Section II-II is the elevation section through the exploded view.

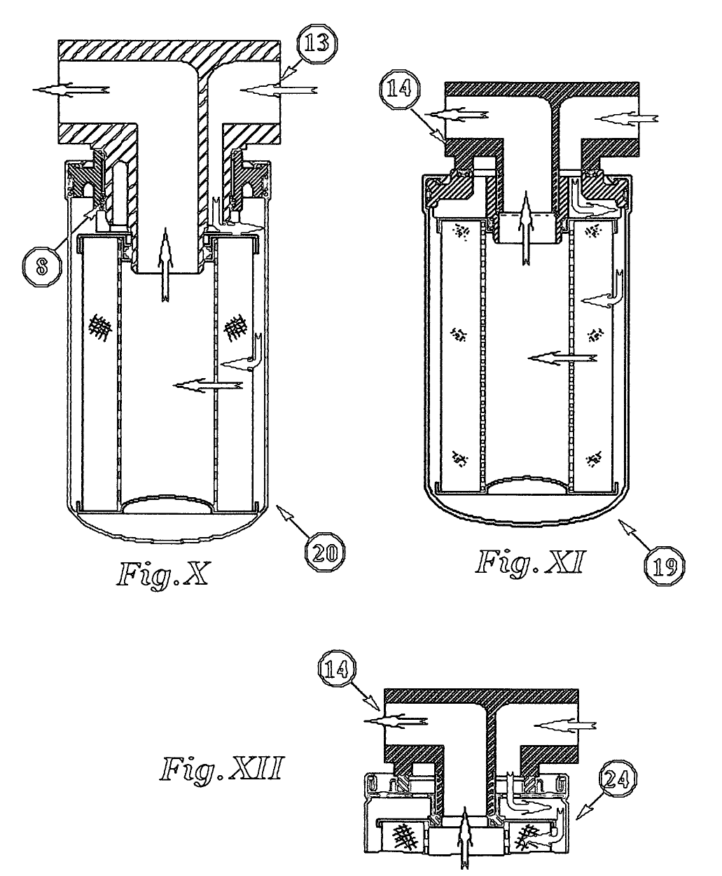

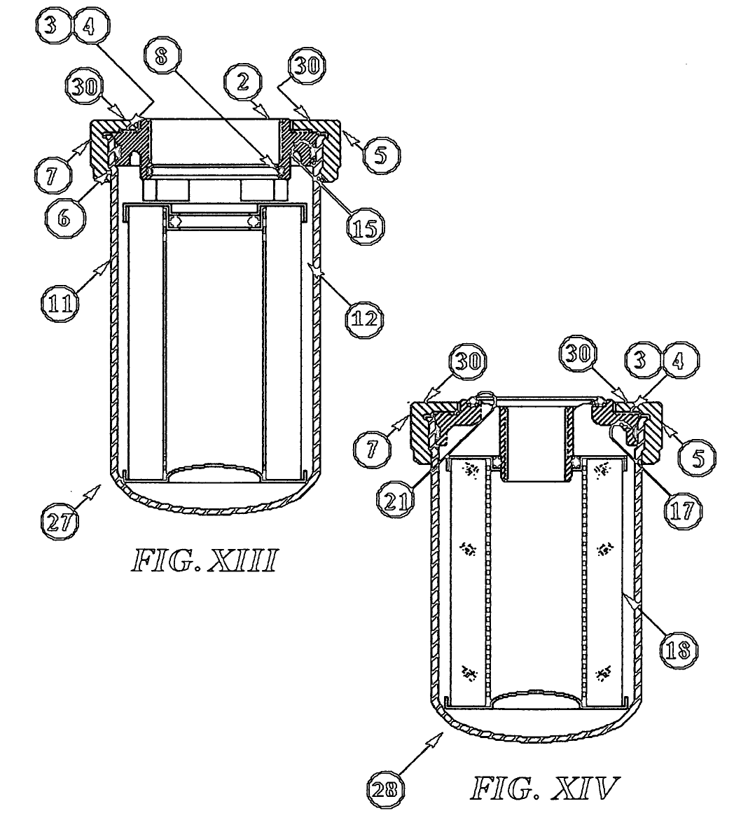

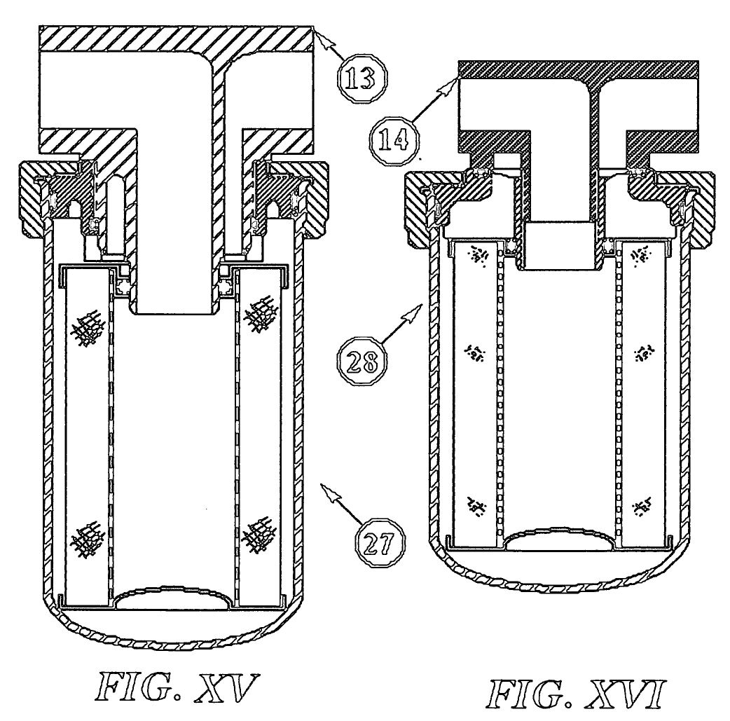

FIG. 11 represents Sec II-II, in FIG. I, in an elevation view.

One particular choice of plate casting, item (2), is preferably made of an aluminum die casting, and its constant features are the keys (3), o-ring seal (9), and the outer portion of plate which nests in the assembled position into the mouth of the shell (11). Seal (8) is a second o-ring radial seal which may be required to adapt to one common filter head. The corner (29) of shell (11) provides the positioning means for the plate (9). Rubber o-ring (9)

effects a radial piston seal with shell (11) when seated within the counterbore (29). Item (8) is an internal, radial, o-ring seal to complete the sealing against internal filter pressure between the assembled spin-on and the mating head. Rings (5) and (7) are moved radially inward to overlap the outer perifery of the plate (2), and to there be positioned so that the ring corner (10) becomes co-incident with shoulder configuration (30) of shell (11). Screws (1) in the assembled position of the ring halves (5) and (7) serve to lock the ring halves into a full 360 degree ring.

FIG. III is an end view of one type of filter head (13) originally intended for attachment of a throw-away spin-on. Section V-V is the main section of the head, showing the attachment profile and the fluid flow passage arrangement.

FIG. IV is an end view of another type of filter head (14) originally intended for attachment of a throw-away spin-on. Section VI-VI is the section through the head which will show the attachment profile and the fluid flow passage arrangement in FIG. V to follow.

FIG. V is the section V-V through the head (13) shown in FIG. III. This section will be used to later illustrate the common matings of throw-away spin-ons and also the alternative, permanent embodiment spin-ons of the invention

FIG. VII represents a common style of hydraulic spin-on (20) which normally attaches to the head of FIG. (13) and which is candidate for the invention format. The plate (2) also nests and an extended length of said counterbore metal folds inwardly (16), in order to retain the plate (2), and which folding renders the spin-on not re-usable with a fresh element. Rubber seal (15) is the external seal against fluid pressure between plate (2) and the shell. Filter element (12) is shown positioned in the shell.

FIG. VIII represents a second style of throw-away, hydraulic spin-on (19) which attaches to a style of head (14). The invention is candidate for substitution of item (19). The plate (17) is characterized by multiple fluid flow passages (29) which derives a rubber face seal (21) to act as external seal between the spin-on (19) and the head (14). Filter element (18) is the typical style of construction for spin-on item (19). Also typical of this constructional style is the shell metal folding inwardly (16, which folding renders the spin-on not re-usable with a fresh element.

FIG. IX represent a third style of throw-away spin-on (24); one which would normally mate with the head style (14), and which said style spin-on (24) being also a candidate for the invention format. The plate (25) is a heavy metal stamping analagous to that of the cast plate (17) of FIG. VIII. A thinner ring of metal (26) is locked to the plate and provides the dual function of a lock seam (23) and the gasket retaining structure to support the pressure seal for gasket (22).

FIG. X represents a throw-away spin-on (20), as mated with its designed-for filter head (13). The invention replacement will connect also to head (13).

FIG. XI represents a throw-away spin-on (19), as mated with its designed-for filter head (14). The invention replacement will connect also to head (14).

FIG. XII represents an alternateconstructional style of throw-away spin-on (24), which also connects to permanent head, style (14).

FIG. XIII is the invention spin-on (27), in elevation section, which will fit permanent head, style (13). The split rings (7) and (5) are in the effective (bolted) position, forming a full ring. The ring is restrained from separation from the shell (11) by the corner configuration (6), derived from the conjunction of (10) (refer FIG. II) and (30) (refer FIG. II). The secured ring's radial structure extends inwardly (30), to contain the plate (2) against internal fluid pressure when loaded by the internal fluid pressure acting on the plate (2). The thickness of the radial structure (30) is a minimum of four times the thickness of the ductile steel, folded-over rim (16), of the throw-away shell of spin-on (20). Torque to rotate the plate (2) is transmitted via the mating of keys (3) and keyways (4).

FIG. IVX is the invention spin-on (28), in elevation section, to fit head style (14). The split rings (7) and (5) are in the effective (bolted) position, thus forming a full structure ring. The element (18) and the plate (27) are varients to corresponding parts of the above noted spin-on (27).

FIG. XV is the fully mated elevation section of the invention spin-on (27) with head (13).

FIG. XVI is the fully mated elevation section of the invention spin-on (28) with head (14).

What is claimed:

1. A take-apart cannister to replace a throw-away spin-on cannister type of hydraulic filter, with said cannister parts being able to be assembled with a new element, without damage to the original cannister parts.

2. A take-apart cannister of claim 1, consisting of three permanent components, plus screw fasteners. Said three components to consist of:—
(a) A deep drawn, metal shell with an expanded open end (counterbore), with said open end having a chamfer to effect compressive entry of a resilient, radial seal, said seal to be preferably in the form of a standard o-ring.
(b) A single, aluminum die cast, disc-like plate which includes the o-ring radial seal as an external, piston seal, and which said rim thickness of plate exactly fills the depth of the shell counterbore, and which includes those necessary features to mate with the chosen filter head. Additionally, each specific plate configuration chosen includes keys which extend inwardly from the O.D., 180 degrees apart; these to engage in keyways provided in the:
(c) A ring structure consisting of two, thick-bodied halves, which are secured by two screws which clamp the mating surfaces, thus forming the structural equivalent strength of a whole ring. The diametral section of the ring is “el” shaped; the cylindrical section of the “el” parallel to the shell surface is stepped to engage an external shoulder of the shell in order to resist the separation from the shell. The rim section of the ring extends inwardly over the cast plate in order to transmit the hydraulic burst force from the plate to the ring. Keyways at 180 degree intervals engage the keys of the plate as the ring halves are moved radially inward to the 360 degree, butted ring condition; there to be secured by two steel screws.
